(19) United States
(12) Patent Application Publication
(10) Pub. No.: US 2008/0043786 A1
(43) Pub. Date: Feb. 21, 2008

(54) Tunable light source for use in microscopy

(76) Inventors: Stefan Wilhelm, Jena (DE); Volker Gerstner, Jena (DE); Peter Westphal, Jena (DE); Dieter Huhse, Berlin (DE)

Correspondence Address: JACOBSON HOLMAN PLLC, 400 SEVENTH STREET N.W., SUITE 600, WASHINGTON, DC, 20004, US

(21) Appl. No.: 11/889,906

(22) Filed: Aug. 17, 2007

(30) Foreign Application Priority Data
Aug. 17, 2006 (DE) 10 2006 039 083.0

(51) Int. Cl. H01S 3/10

(52) U.S. Cl. 372/20

(57) ABSTRACT

A tunable lighting source, especially for a microscope, which contains a laser, in which the lighting source delivers spectrally variable and spatially coherent radiation. The tunable lighting source is based on a structured substrate coated with a laser medium, the structured substrate provided with the laser medium having a geometrically variable structure and delivering spatially coherent radiation by energy excitation.

### BACKGROUND OF THE INVENTION

(1) Field of the Invention

The invention concerns a tunable lighting source, especially for applications in microscopy, which contains a laser, the lighting source delivering spectrally variable and spatially coherent light. It is still widespread in confocal microscopy to merge lasers with different initial wavelengths via color dividers or similar elements and couple them into the microscope light path. In order to cover the visible spectral range with a sufficient number of laser wavelengths, about 3 to 5 individual lasers must be used. This leads to a high technical expense connected with correspondingly high costs. However, approaches to get by without a number of individual lasers are already known.

(2) Description of Related Art

A light source is described in US 2006/0013270 A1, in which the two laser beams of different wavelength are directed onto a nonlinear optical crystal. The useful light, which can also be used for microscopy, is obtained from the total frequency of the two laser beams. A drawback to this method is that the useful light can only be varied to the extent that the wavelengths of the primary laser beams are variable. This severely restricts the attainable wavelengths of the useful light.

A laser system is described in U.S. Pat. No. 6,154,310 B1, in which ultrashort pulses are coupled into an optical coupler. In each branch, wavelength conversion occurs via harmonic or parametric generation. The branches are then combined again into a beam. A shortcoming in this system for microscopy is that, after conversion, only a few discrete wavelengths are available.

U.S. Pat. No. 6,888,674 B1 describes a scanning microscope, containing a primary laser and an optical component that spectrally widens the primary laser light directly, so that it contains a substantial fraction of the total visible spectrum behind the optical component. The desired wavelengths are separated from this spectrum.

A tunable DFB (distributed feedback) laser is described in EP 0 360 011 B1, which is tunable over a range of up to 10 nm at a wavelength of 1.55 μm. The DFB laser operates based on a pure inorganic semiconductor structure and is electrically pumped.

So-called DFB structures are known. S. Riechel et al., “Very compact tunable solid-state laser utilizing a thin-film organic semiconductor,” Optics Letters, Vol. 26, No. 9, 2001, 593-595, describes a compact solid laser that contains a diode-pumped Nd:YAG laser, whose radiation is converted by a structured organic laser material. W. Kowalsky et al., “Organic semiconductor distributed feedback lasers,” Proceedings of SPIE—Volume 6008, Nanosensing: materials and Devices II, M. Saif Islam, Achyut K. Dutta, Editors, 60080Z (Nov. 17, 2005), describes different organic laser materials for DFB lasers.

The underlying task of the invention is to provide a comparatively simply designed, tunable lighting source that makes generation of numerous discrete wavelengths in the visible spectral range possible and, in which the different wavelengths of the light can be simply selected.

### BRIEF SUMMARY OF THE INVENTION

According to the invention, a structured substrate provided with a laser medium is used, which is characterized as a DFB structure (DFB=distributed feedback), a DBR structure (DBR=distributed Bragg reflection) and/or a 2DPC structure (2DBC=2D photonic crystal). An advantageous embodiment of the invention occurs based on a DFB structure, in which the DFB structure has a grating constant. The DFB structure is coated with a laser medium that can be optically or electrically excited, which consists of an organic or inorganic dye.

The variability is achieved, on the one hand, in that the DFB structure can be elongated or compressed perpendicular to the propagation direction of the grating lines by means of a force vector. The variability is achieved, on the other hand, in that the DFB structure has at least two partial areas, each of which has a different grating constant and/or a different laser medium, only one partial area being excitable optically or electrically to emission by exposure to excitation light.

The choice of the corresponding partial area occurs electrically by selective control of the corresponding partial area, in which this partial area can be positioned by a mechanical guide and adjustment device relative to the optical path of the following optical system. The choice of the corresponding partial area occurs optically through a selective exposure of the corresponding partial area, this partial area being positionable by a mechanical guide and adjustment device relative to the optical path of the excitation source and the following optical system.

DFB structures are grating structures that permit laser emission to be established within the amplification profile of the laser medium by a variation of the grating constants. Design overlapping of partial waves reflected by the different grating grooves leads to increased reflection of the corresponding wavelength and therefore frequency selection. Since a spatially extended grating is involved in the DFB structures, the conditions of Bragg reflection apply. Organic dyes with amorphous structure should be considered here as laser medium. By adjustment of the DFB structure in conjunction with corresponding variation of the organic substances, almost any wavelength can be adjusted from the visible spectral range.

Tunability is achieved by introducing various cost-effective dye-DFB structure combinations in time succession into the optical path. A compact and easily handled tunable laser light source is obtained accordingly. The coherent lighting source furnishes radiation in the spectral range from UV (about 350 nm) to IR (about 1300 nm), preferably in the range between 365 nm to 800 nm, in which this radiation can be selected narrowband (Δλ<5 nm) and in the spectral range or in partial areas continuously or in small steps (<20 nm). The following are considered as laser media on the DFB structures: organic dyes, organic semiconductors, quantum dots and other inorganic dyes.

Instead of simple DFB structures, phase-shifted DFB structures can be used (to achieve better single-mode emission). A significant improvement in emission characteristics is achieved by the use of 2D periodic-modulated substrates. The specific properties of light propagation in such 2D photonic crystals lead to monomode laser activity. The tunable lighting source is used, especially in a microscope to illuminate and/or manipulate a sample.

An important area of application of the microscope according to the invention is fluorescence microscopy. It is particularly suited for simultaneous excitation of several fluorescence dyes. Since the lighting source of the microscope makes visible light and infrared radiation available, it is suitable for both single-photon and multiphoton excitation.

The newly generated laser light in the microscope arrangement is used both for excitation of fluorescence dyes (for example, in fluorescence microscopy) and for manipulation (for example, bleaching-out of dyes or micromanipulation of cells by optical forces) or for special applications, like TIRF (total internal reflection). During use of a pulsed/mode-coupled UV pump laser (repetition rate >20 MHz, pulse length <100 ps), FLIM (fluorescence lifetime imaging) measurements are conducted with simultaneous full acquisition of functionality for normal imaging. Ideally, these laser systems are at 355 nm and are particularly stable and compact.

The new lighting source is used, in particular, in a point-scanning or line-scanning microscope that operates confocally or partially confocally. The lighting source also finds application in a microscope that operates according to the SPIN principle (selective plane illumination microscopy). The microscope, however, can also be an optically operating cytometer or an optically operating biochip reader. Use of the lighting source in a wide field microscope or a material microscope or a CARS microscope arrangement is also prescribed. It can be advantageously used in CARS (coherent anti-Stokes Raman spectroscopy), in which the at least two different wavelengths, necessary for CARS, can be varied continuously with the new lighting source. The lighting source is used for both fluorescence excitation and for manipulation of microscopic object.

### BRIEF DESCRIPTION OF THE SEVERAL VIEWS OF THE DRAWINGS

FIG. 1 schematically illustrates a view of a DFB structure, whose diffraction grating is expandable;

FIG. 2 shows a schematic view of a DFB structure with partial areas, whose diffraction gratings have different grating constants;

FIG. 3 shows a schematic view of a DFB structure with partial areas, whose diffraction gratings have a different grating constant and different dyes as laser material;

FIG. 4 shows a schematic view of a tunable lighting source;

FIG. 5 shows a schematic view of a tunable lighting source for a microscope illumination with an AOTF;

FIG. 6 shows a schematic view of a tunable lighting source for a microscope illumination with am AOM;

FIG. 7 shows a schematic view of a tunable lighting source for a microscope illumination with two laser wavelengths;

FIG. 8 shows a schematic view of a tunable lighting source for a microscope illumination with two wavelengths that can be modulated separately;

FIG. 9 shows a schematic view of a tunable lighting source for a microscope illumination, whose laser medium can be electrically excited; and

FIG. 10 shows a schematic view of a matrix of DFB structures.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

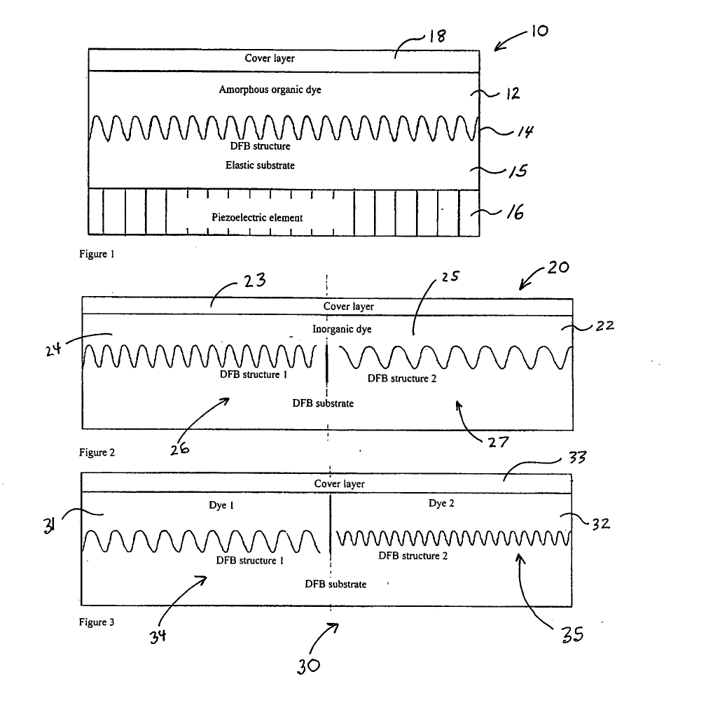

FIG. 1 shows a schematic illustration of a DFB laser structure 10 with an amorphous organic dye 12 on a Bragg reflection grating 14, which is introduced to an elastically extendable substrate 15. A cover layer 18 is applied in the form of an oxidation layer to the dye. The substrate is connected to a piezoelectric element 16 that can be controlled electrically. Expansion of the piezoelectric element occurs in the direction of the grating period. Depending on the applied voltage, the grating distance is expanded or compressed in discrete steps or continuously.

FIG. 2 shows a schematic illustration of a DFB laser structure 20, having two partial areas 24,25 with an inorganic dye 22 and a cover layer 23 as an oxidation layer. There are two Bragg reflection gratings 26,27. Each of the partial areas 24,25 has a different grating constant, so that coherent radiation of different wavelengths is generated, depending on energy excitation.

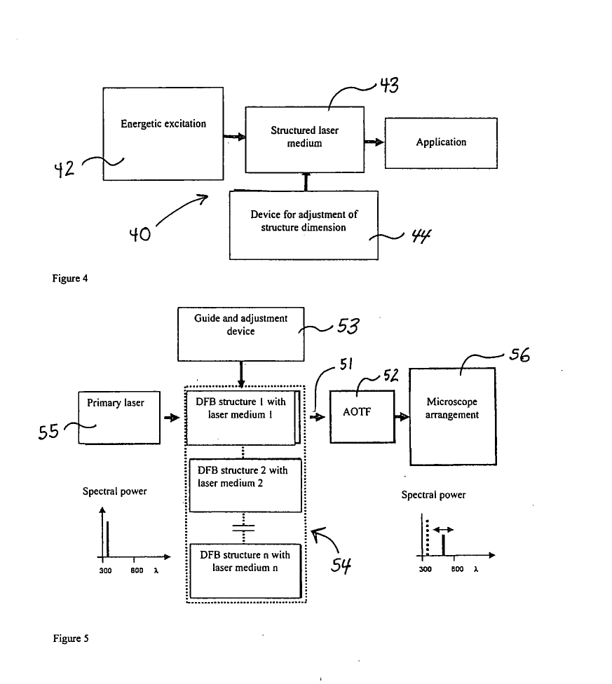

FIG. 3 shows a schematic illustration of a DFB laser structure 30 that has two partial areas 31,32 with a different dye and a cover layer 33 as an oxidation protection. Each of the partial areas also has a different grating constant, as well as a different profile depth of the Bragg reflection grating 34,35, so that coherent radiation of different wavelengths is generated, depending on energy excitation.

FIG. 4 schematically depicts a practical example of a lighting source 40 that is prescribed especially for a microscope. The radiation of a primary pump laser, preferably a frequency-tripled NdYAG laser at 355 nm (mode-coupled or cw), produces an energy excitation 42 of a structured laser medium 43. The laser medium in the example is an amorphous organic dye constructed on the Bragg reflection grating structure. As in each optically-pumped laser, the gain medium (the organic compound) generates optical amplification in a wavelength range corresponding to the spectral width of the gain medium. This wavelength range normally is shifted to longer wavelengths relative to the pump wavelength. Via the DFB structure, according to the conditions for Bragg reflection, laser light is emitted with a wavelength established by the period of the Bragg grating. The intensity of the emitted laser light then also depends on the laser media themselves.

By means of the DFB structure (resonator) in conjunction with the organic laser medium, coherent radiation is therefore generated at a new wavelength (generally greater than the pump wavelength). Via the grating constant of the DFB structure in conjunction with the laser medium, the generated wavelength is deliberately chosen and altered. A tunable light source can be obtained if several laser media with adapted DFB structures are introduced to the beam of the pump laser by means of a device to adjust the structure dimension in time succession 44, during displacement of the DFB structures relative to the pump beam. Since an organic dye as laser medium can emit different wavelengths lying close to each other by combination of different DFB structures, it is possible to obtain an almost continuous spectrum. The laser radiation is then supplied to an application, especially a microscope arrangement.

Coupling to the microscope arrangement can then also occur with fiber optics. Advantageously, the pump laser is switched off or blocked when the useful light obtained by the DFB structure is not required, in order to increase the useful life of the dyes serving as laser medium. In addition, the beam generated by the pump laser is positioned on different locations of the corresponding DFB structure, in order to prevent bleaching-out of one location, and therefore increase the useful life of the DFB structure.

FIG. 5 schematically illustrates a practical example according to FIG. 4, in which modulation of the laser light necessary for the application is achieved in the μs range, by guiding the newly generated laser light 51 additionally through an AOTF 52 (acousto-optical tunable filter). A guide and adjustment device 53 positions the corresponding combination of the DFB structure and laser medium 54 in the optical path between the primary pump laser 55 and the microscope arrangement 56.

FIG. 6 shows another practical example according to FIG. 5, where like reference numerals denote like elements. In the embodiment of FIG. 6, the pump light 61 of the DFB structure is modulated by a cost-effective AOM 62 (acousto-optical modulator) and the modulation of the laser light necessary for the application is achieved in the μs range.

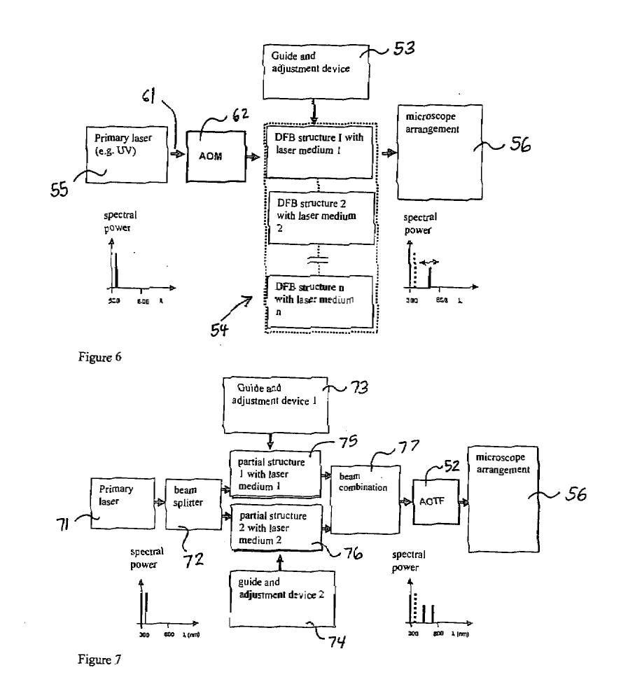

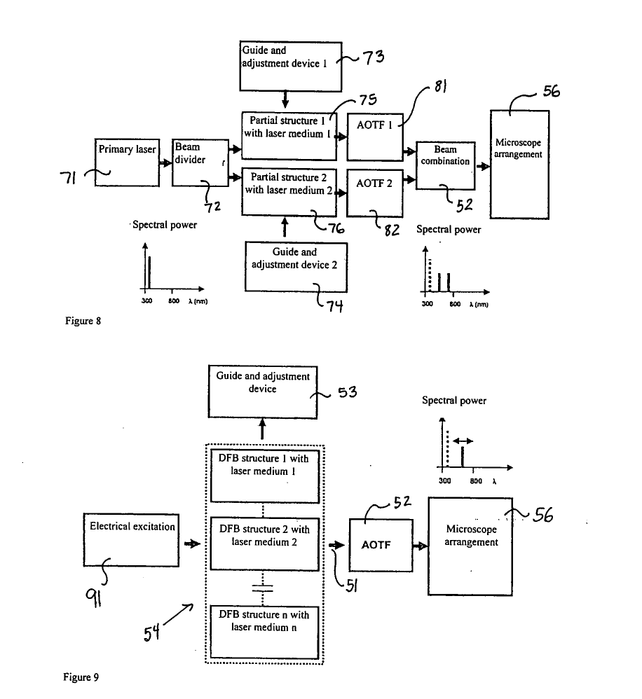

FIG. 7 schematically illustrates another practical example for application of the lighting source in a microscope. Since in many experiments in confocal laser scan microscopy, multiple colors of the sample are common, a light source that simultaneously emits at least two wavelengths is desirable in many cases. For this purpose, the radiation of a primary pump laser 71, preferably a UV laser in the wavelength range 337 nm to 355 nm is divided by a spectrally neutral beam divider 72.

A first part of the radiation is introduced to a first partial structure of a first substrate 75, having several partial areas. This partial structure is coated with a first organic compound as a laser medium. A second part of the radiation is introduced to a second partial structure of a second substrate 76, which also has several partial areas. This partial structure is coated with a second organic compound as a laser material. By means of the two DFB structures, coherent radiation at two new wavelengths is therefore generated. By selecting the corresponding DFB structure with the corresponding guide and adjustment devises 73,74, the generated wavelength composition is deliberately chosen and varied, i.e., each of the two branches is independently tunable. A division into more than two channels is provided, just as the variation of units from the DFB structure and laser medium within the branches.

The newly generated laser light is then combined again to a beam via a dichroic filter 77 (beam combination) and passed through an AOTF 52 (acousto-optical tunable filter), with which it can be varied very quickly relative to optical power. The two beams are then overlapped and fed into the already described type of microscope arrangement 56.

FIG. 8 shows another practical example according to FIG. 7, in which the generated laser beam of each branch is guided via an AOTF 81,82. The advantage here is that the light fractions are adjusted independently of each other and each AOTF is chosen in optimized fashion for the spectral ranges being controlled. AOTF 1 thus modulates a spectral range from 400 nm to 450 nm and AOTF 2 a spectral range from 450 nm to 650 nm.

FIG. 9 shows a lighting source according to FIG. 5, in which energy excitation 91 here occurs directly electrically for the active DFB structure.

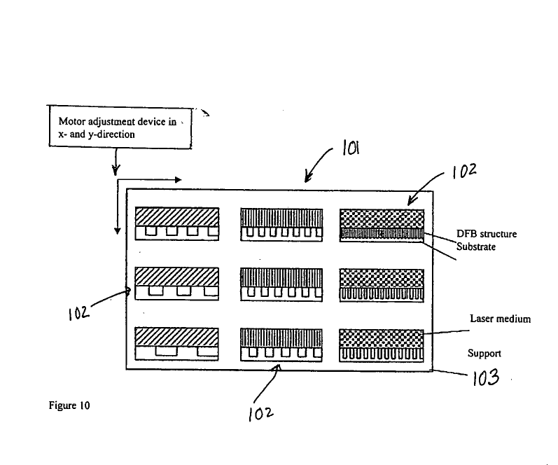

FIG. 10 schematically depicts a matrix of DFB structures on a support, which is mounted movable in the x- and y-direction, and whose partial areas can be positioned by means of a motor adjustment device in the optical path of the application. In the example, three different laser materials and nine different structures with different grating constants are schematically shown rotated out from the plane of the drawing by 90°. Such a matrix is used in the arrangements according to FIGS. 6, 7, 8 and 9. For one or each of the partial structures or for the partial structures referred to as DFB structures, one matrix is used, in which one partial area of each matrix is positioned in the optical path of the application.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A tunable lighting source, for use with a microscope that contains a laser, in which the lighting source delivers spectrally variable and spatially coherent radiation, the tunable lighting source comprising: a structured substrate; and a laser medium coating the substrate, the laser medium having a geometrically variable structure, wherein the structured substrate provided with the laser medium produces the spatially coherent radiation by energy excitation.

2. The tunable lighting source according to claim 1, further comprising a force vector, wherein the variability is produced by the geometric structure, which is elongated or compressed by means of the force vector.

3. The tunable lighting source according to claim 1, wherein the variability is produced by the structured substrate provided with the laser medium, which has at least two partial areas, each of which has a different geometric structure and/or a different laser medium, in which only one partial area delivers the spatially coherent light by energy excitation.

4. The tunable lighting source according to claim 3, wherein the energy excitation occurs by exposure to excitation light or directly electrically.

5. The tunable lighting source according to claim 3, further comprising an electric controller and a mechanical guide and adjustment system, wherein the choice of a corresponding partial area of the substrate can be carried out by selective electrical control of the corresponding partial area by the electric controller, this partial area being positionable by the mechanical guide and adjustment system.

6. The tunable lighting source according to claim 3, further comprising an excitation light and a mechanical guide and adjustment system, wherein the choice of a corresponding partial area of the substrate can be carried out by selective exposure of the corresponding partial area with the excitation light, this partial area being positionable by the mechanical guide and adjustment system.

7. The tunable lighting source according to claim 4, wherein the more than one substrate has different geometric structures and/or different laser media and these substrates are fastened to a support, which can be positioned by a mechanical guide and adjustment device to an optical path.

8. The tunable lighting source according to claim 1, further comprising more than one structured substrate provided with a laser medium, the multiple structured substrates can be energetically excited simultaneously, each structured substrate provided with a laser medium being dimensioned, so that different wavelengths of coherent radiation can be generated simultaneously.

9. The tunable lighting source according to claim 7, further comprising a beam splitter wherein the radiation of the excitation light with wavelength (λ₁) is divided by means the beam splitter, and partial beams expose a partial area of each of the structured substrates provided with a laser medium with excitation light.

10. The tunable lighting source according to claim 1, wherein the coherent radiation is fed to an electrically controllable switch/modulator.

11. The tunable lighting source according to claim 10, further comprising an intensity modulator and a control circuit, wherein measurement of the time fluctuations of the coherent radiation occurs and this radiation is fed to the intensity modulator that is controlled by the control circuit.

12. The tunable lighting source according to claim 1, wherein the coherent radiation can be fed to a spectral filter.

13. The tunable lighting source according to claim 12, wherein the coherent radiation is fed to a spatial filter after the spectral filter.

14. The tunable lighting source according to claim 1, wherein the structured substrate provided with a laser medium is a DFB structure or DBR structure or 2D photonic crystal structure, in which its variability can be produced by different or adjustable structure spacings and/or structure sizes.

15. The tunable lighting source according to claim 14, wherein the laser medium is an organic or inorganic laser medium coating the structured substrate.

16. The tunable lighting source according to claim 1, wherein more than one structured substrate coated with a laser medium is arranged in an illumination optical path of an application, in which the corresponding structures can be excited energetically individually or together.

17. The tunable lighting source according to claim 4, further comprising a glass fiber wherein the coherent radiation can be fed to an application by means of the glass fiber.

18. Use of the tunable lighting source according to claim 1, wherein the microscope is a laser-scanning microscope, a selective plane illumination microscope, and/or a fluorescence microscope.

19. Use of the tunable lighting source according to claim 1, wherein the coherent radiation is used for illumination for micromanipulations, for total internal reflection microscopy and/or fluorescence lifetime imaging microscopy.
